(19) United States
(12) Patent Application Publication
(10) Pub. No.: US 2011/0289298 A1
(43) Pub. Date: Nov. 24, 2011

(54) SEMICONDUCTOR CIRCUIT AND DESIGNING APPARATUS

(75) Inventor: Masayuki TSUJI, Yokohama (JP)

(73) Assignee: FUJITSU SEMICONDUCTOR LIMITED, Yokohama (JP)

(21) Appl. No.: 13/028,840

(22) Filed: Feb. 16, 2011

(30) Foreign Application Priority Data
May 19, 2010 (JP) 2010-115552

(51) Int. Cl. G06F 9/30

(52) U.S. Cl. 712/202; 712/E09.016

(57) ABSTRACT

A semiconductor circuit includes a memory which stores data; a processing device which executes a program, writes argument data of a function of the program into the memory referring to an address stored in a stack pointer, when a value of a program counter, which indicates an address of the program under execution, reaches a hardware accelerator starting address, and outputs the address stored in the stack pointer; and a hardware accelerator which receives the address of the stack pointer from the processing device, when a value of the program counter of the processing device reaches the hardware accelerator starting address, reads the argument data of the function from the memory referring to the address stored in the stack pointer, and executes the function implemented in hardware using the argument data.

### CROSS-REFERENCE TO RELATED APPLICATION

This application is based upon and claims the benefit of priority of the prior Japanese Patent Application No. 2010-115552, filed on May 19, 2010, the entire contents of which are incorporated herein by reference.

### FIELD

The embodiments discussed herein are directed to a semiconductor circuit and a designing apparatus.

### BACKGROUND

With advancement of the degree of integration of semiconductor circuit, applications of SoC (system-on-a-chip) have been becoming more complicated and increased in scale from year to year, so that processing capacities required for processing device and DSP (digital signal processing device) used therefor have ceaselessly been increasing. On the other hand, while the processing capacities of processing device and DSP have been improved keeping pace with the technology, further improvement in the operation frequency relying upon dimensional shrinkage of the semiconductor circuit has been no more expectable in recent years, due to increase in power consumption. Accordingly, an alternative technique having been adopted is such as adding a command specialized for a specific application, to thereby enhance the processing capacity.

FIG. 1 is a drawing illustrating an exemplary configuration of SoC. An SoC 101 has an internal bus 111, a central processing unit (CPU) 112, a hardware accelerator 113, an internal memory 114 and a memory controller 115. The hardware accelerator 113 has a finite state machine 131, a control register 132, a base address storage unit 133 and an adder 134. The internal memory 114 stores an address table 121 and I/O data 122. The central processing unit 112, the hardware accelerator 113, the internal memory 114 and the memory controller 115 are connected to the internal bus 111. The memory controller 115 controls an external memory 102.

An application of the SoC 101 may be divided into a software section governed by the central processing unit 112, and a hardware section governed by the hardware accelerator 113. The central processing unit 112 and the hardware accelerator 113 are connected to the internal bus 111, so as to share the internal memory 114. In order to allow the hardware accelerator 113 to operate, a control register 132 of the hardware accelerator 113 is defined. The control register 132 is assigned with processes to be executed by the finite state machine 131 in a bit-by-bit manner. The central processing unit 112 reads a base address, which is used for memory access by the hardware accelerator 113, through a path 141 from the address table 121 of the internal memory 114, and writes the base address to the base address storage unit 133 in the hardware accelerator 113 through a path 142. The central processing unit 112 also writes data to the individual bits of the control register 132 through the path 142. Upon writing of data into the control register 132, the finite state machine 131 executes the process referring to values of the individual bits in the control register 132. For example, the finite state machine 131 outputs a data read-out address to the adder 134. The adder 134 adds the base address of the base address storage unit 133 and the data read-out address of the finite state machine 131, and outputs an address of the internal memory 114. The finite state machine 131 reads data 122 from the internal memory 114 referring to the output address from the adder 134 through the path 143, and executes a predetermined process of the read data. The finite state machine 131 then outputs a data write-in address to the adder 134. The adder 134 adds the base address of the base address storage unit 133 and the data write-in address of the finite state machine 131, and outputs an address of the internal memory 114. The finite state machine 131 writes the thus-processed data to the internal memory 114 through the path 143, referring to the address output from the adder 134. Upon completion of the process corresponding to the value of the control register 132, the finite state machine 131 outputs an interruption signal 144 for posting completion of the process to the central processing unit 112.

Another device having been known is a device for data processing, which has a programmable general-purpose processing device which operates under control by a command of a program for executing a data process operation, a memory system connected to the processing device, a hardware accelerator connected to the processing device and the memory system, and a system monitoring circuit connected to the hardware accelerator (see, Japanese Laid-Open Patent Publication No. 2009-140479, for example).

A method having been known is a method of dividing specification written in source code, which includes a step of converting the specification into a plurality of abstract syntax trees, a step of dividing the plurality of abstract syntax trees into a group of first abstract syntax trees to be embodied by a first processing device and a group of second abstract syntax trees to be embodied by a second processing device (see Japanese National Publication of International Patent Application No. 2005-534114, for example).

Another method having been known is a method of dynamically linking a program for the case where a function was called from an arbitrary program by specifying a function identifier and arguments. The method includes a process of saving data necessary for return to a program, out of data stacked over the function identifier and the arguments on a stack; a process of executing a function corresponded to the function identifier using the arguments on the stack; and a process of returning, after execution of the function, the saved data necessary for return to a predetermined position on the stack (see Japanese Laid-Open Patent Publication No. H07-134650, for example).

In order to divide the software section governed by the central processing unit 112 and the hardware section governed by the hardware accelerator 113, a control register 132 is defined as an interface therebetween. The central processing unit 112 writes a value into the control register 132 by executing a program (software), to thereby make the hardware accelerator 113 operate. The method, however, needs additional task of designing the definition of the control register 132, and the software additionally needs a description for controlling the control register 132, enough to increase the working time, and to cause overhead in terms of process performance.

### SUMMARY

According to an aspect of the embodiment, a semiconductor circuit includes a memory which stores data; a processing device which executes a program, writes argument data of a function of the program into the memory referring to an address stored in a stack pointer, when a value of a program counter, which indicates an address of the program under execution, reaches a hardware accelerator starting address, and outputs the address stored in the stack pointer; and a hardware accelerator which receives the address of the stack pointer from the processing device, when a value of the program counter of the processing device reaches the hardware accelerator starting address, reads the argument data of the function from the memory referring to the address stored in the stack pointer, and executes the function implemented in hardware using the argument data.

Additional objects and advantages of the embodiment will be set forth in part in the description which follows, and in part will be obvious from the description, or may be learned by practice of the invention.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a drawing illustrating an exemplary configuration of an SoC;

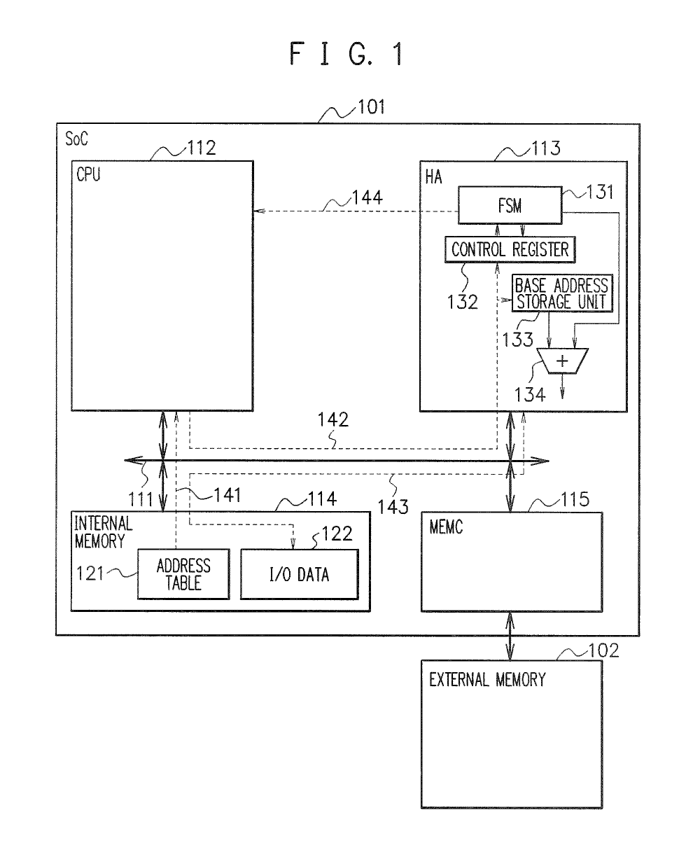

FIG. 2 is drawing illustrating an exemplary configuration of SoC (semiconductor circuit) according to an embodiment;

FIG. 3 is a drawing illustrating an exemplary specific configuration of a hardware accelerator illustrated in FIG. 2;

FIG. 4 is a drawing illustrating exemplary processing executed by a central processing unit, an internal memory and a hardware accelerator;

FIG. 5 is a drawing illustrating a method of designing the SoC;

FIG. 6 is a flowchart illustrating details of the method of designing illustrated in FIG. 5; and

FIG. 7 is a drawing illustrating an exemplary hardware configuration of the computer (designing apparatus) illustrated in FIG. 5.

### DESCRIPTION OF EMBODIMENT(S)

Preferred embodiments of the embodiments will be explained with reference to accompanying drawings.

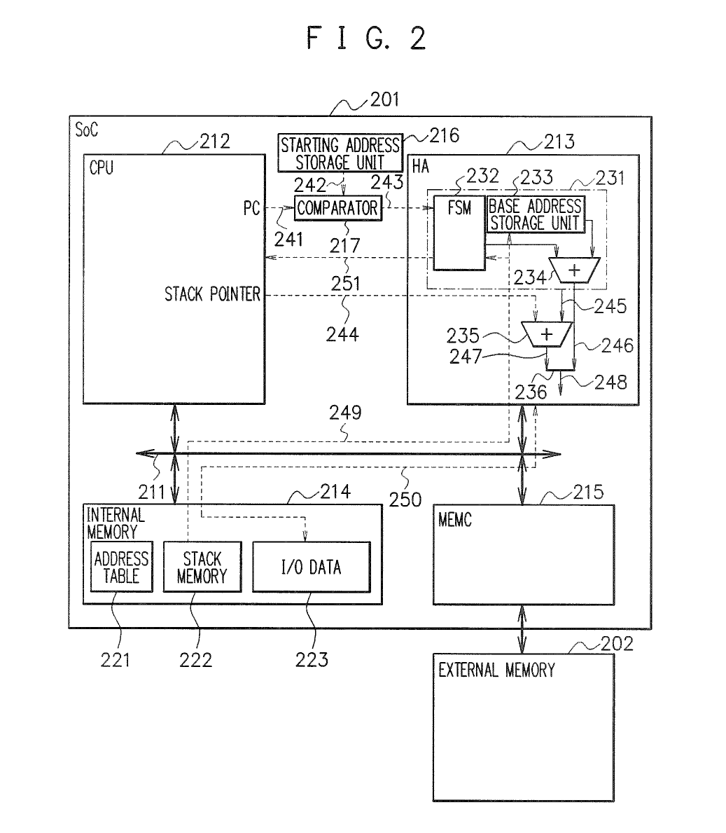

FIG. 2 is a drawing illustrating an exemplary configuration of an SoC (semiconductor circuit) according to an embodiment. An SoC 201 is a semiconductor circuit, and has an internal bus 211, a central processing unit (CPU) 212, a hardware accelerator (HA) 213, an internal memory 214, a memory controller 215, a hardware accelerator starting address storage unit 216 and a comparator 217. The hardware accelerator 213 has a function 231 implemented in hardware, a first adder 235 and a selector 236. The function 231 implemented in hardware has a finite state machine 232, a base address storage unit 133 and a second adder 234. The internal memory 214 has a stack memory 222, and stores an address table 221 and I/O data 223. The central processing unit 212, the hardware accelerator 213, the internal memory 214 and the memory controller 215 are connected to the internal bus 211. The memory controller 215 controls an external memory 202. The central processing unit 212 may be a processing device, or a sort of processing device such as DSP.

In this embodiment, an arbitrary function of an application of the SoC 201 is implemented in hardware, and the function 231 implemented in hardware is provided in the hardware accelerator 213. The central processing unit 212 executes the program and outputs a value 241 of a program counter which indicates an address where the program is executed. The hardware accelerator starting address storage unit 216 stores a hardware accelerator starting address 242. The hardware accelerator starting address 242 is a starting address of a function in the program executed in the central processing unit 212. The central processing unit 212 executes the program, writes argument data of the function in the program and base address into the stack memory 222 of the internal memory 214 referring to an address stored in the stack pointer, when the value 241 of the program counter reaches the hardware accelerator starting address 242, and then outputs an address 244 of the stack pointer 244. Thereafter, the central processing unit 212 executes a process for waiting completion of operation by the hardware accelerator 213, such as infinite loop operation or issuance of sleep command.

The comparator 217 compares the value 241 of the program counter and the hardware accelerator starting address 242, and outputs a match signal 243 if the both match. Upon output of the match signal 243 by the comparator 217, the hardware accelerator 213 judges that the value 241 of the program counter reached the hardware accelerator starting address 242, receives the address stored in the stack pointer 244 from the central processing unit 212, reads the argument data of the function from the internal memory 214 referring to the address stored in the stack pointer 244, and executes the function 231 implemented in hardware using the argument data. More specifically, the finite state machine 232 executes the function 231 implemented in hardware using the argument data.

A specific example will be explained below. The finite state machine 232 outputs a stack readout address 245. The first adder 235 adds the address stored in the stack pointer 244 and the stack readout address 245, and outputs an address 247 of the internal memory 214. The selector 236 selects the address 247, and outputs the selected address 247 as an address 248 to the internal memory 214. The finite state machine 232 reads the argument data of the function and base address from the stack memory 222 through a path 249, referring to the address 247 of the internal memory 214 output from the first adder 235. Next, the finite state machine 232 writes the thus-read base address to a base address storage unit 233.

Note that the base address is not always necessarily stored in the stack memory 222. For example, the base address may preliminarily be stored in the address table 221. In this case, the finite state machine 232 reads the base address from the address table 221, and writes the thus-read base address into the base address storage unit 233.

The function 231 implemented in hardware is a function in a program, implemented in hardware by high-level synthesis. The high-level synthesis is a process for generating RTL design data implemented in hardware, based on a program written in high-level language such as System C. For example, by aligning arguments of a function into a local alignment in the process of high-level synthesis, the hardware accelerator 213 is enabled to read the arguments of the function from the stack memory 222.

Next, the finite state machine 232 outputs the data read-out address to the second adder 234. The second adder 234 adds the base address stored in the base address storage unit 233 and the data read-out address output by the finite state machine 232, and outputs an address 246 of the internal memory 214. The selector 236 selects the address 246, and outputs the thus-selected address 246 as the address 248 to the internal memory 214. The finite state machine 232 reads data 223 from the internal memory 214 through a path 250, referring to the address 246 output by the second adder 234, and executes a predetermined process of the read data.

Next, the finite state machine 232 outputs a data write-in address to the second adder 234. The second adder 234 adds base address stored in the base address storage unit 233 and the data write-in address output by the finite state machine 232, and outputs the address 246 of the internal memory 214. The selector 236 selects the address 246, and outputs the thus-selected address 246 as the address 248 to the internal memory 214. The finite state machine 232 writes the thus-processed data through the path 250 into the internal memory 214 referring to the address 246 output by the second adder 234.

Next, upon completion of the process of the function 231 implemented in hardware, the finite state machine 232 outputs an interruption signal 251 for posting completion of the process to the central processing unit 212. Upon reception of the interruption signal 251 for posting completion of the process, the central processing unit 212 cancels the state of waiting for completion of process of the hardware accelerator 213, and restarts the succeeding process of the program. Cancellation of the state of waiting for completion of process of the hardware accelerator 213 may be exemplified by a process of quitting an infinite loop, canceling a sleep command, and so forth.

Note that the central processing unit 212 is not always necessarily required to cancel the state of waiting for completion of process of the hardware accelerator 213. For an exemplary case where the succeeding processes of the program are irrelevant to the function 231 implemented in hardware, the hardware accelerator 213 may execute the succeeding processes of the program while the function 231 implemented in hardware is processed.

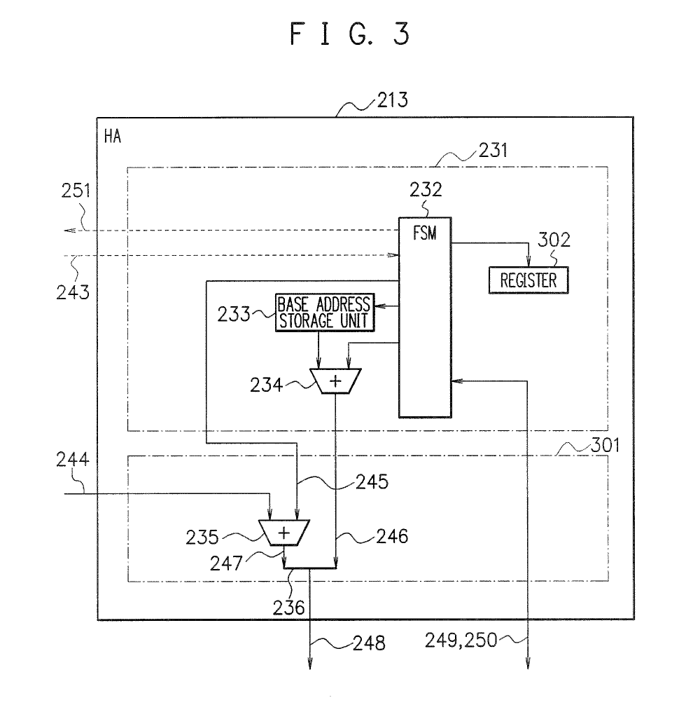

FIG. 3 is a drawing illustrating a specific configuration of the hardware accelerator 213 illustrated in FIG. 2. The hardware accelerator 213 illustrated in FIG. 3 is configured by adding an interface 301 and a register 302 to the hardware accelerator 213 illustrated in FIG. 2. The hardware accelerator 213 illustrated in FIG. 3 will be explained below, referring to aspects different from those of the hardware accelerator 213 illustrated in FIG. 2. The interface 301 has the first adder 235 and a selector 236, so as to enable the function 231 implemented in hardware to access the internal bus 211 illustrated in FIG. 2. Upon selection of the address 247 by the selector 236, an address of the stack memory 222 is specified, and the finite state machine 232 reads argument of a function from the stack memory 222 through the path 249, and writes the thus-read arguments of the function as local variables into the register 302. Next, the finite state machine 232 executes the function 231 implemented in hardware, using the arguments of the function stored in the register 302.

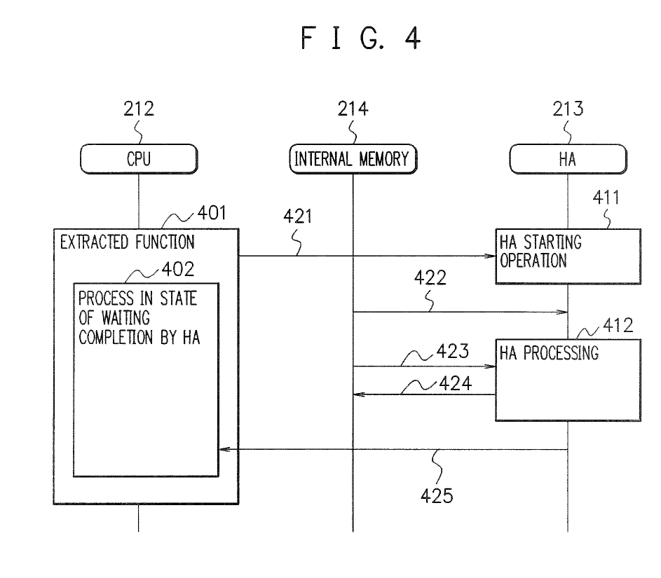

FIG. 4 is a drawing illustrating exemplary operations of the central processing unit 212, the internal memory 214 and the hardware accelerator 213. The central processing unit 212 executes a function 401 extracted from the program. In order to enable the hardware accelerator 213 to execute a process of the function 401 having arguments in the program to be processed by the central processing unit 212, the process of the function 401 having arguments in the program to be processed by the central processing unit 212 is replaced by a process 402 in the state of waiting completion by the hardware accelerator 213. Upon start of execution of the function 401, the central processing unit 212 outputs a value of the program counter and an address 421 stored in the stack pointer to the hardware accelerator 213, and execute a process 402 in the state of waiting completion by the hardware accelerator 213. Upon output of the match signal 243 by the comparator 217, the hardware accelerator 213 executes activation 411. Next, the hardware accelerator 213 reads the argument data of the function and base address 422 out from the stack memory 222 of the internal memory 214, based on the address 421 stored in the stack pointer. Next, the hardware accelerator 213 reads data 423 out from the internal memory 214 based on the base address 422, and executes a predetermined process using the argument data. Next, the hardware accelerator 213 writes thus-processed data 424 into the internal memory 214 based on the base address 422. Next, upon completion of execution of the function, the hardware accelerator 213 outputs an interruption signal 425 for posting completion of the process to the central processing unit 212. Upon reception of the interruption signal 425 for posting completion of the process, the central processing unit 212 cancels the process 402 in the state of waiting for completion of process, and restarts the succeeding process of the program.

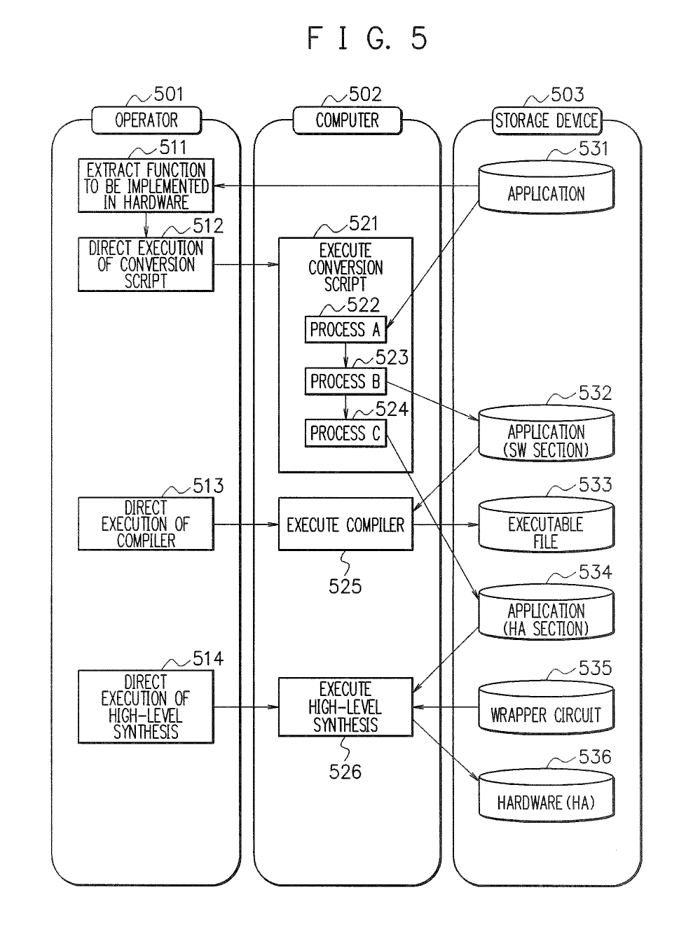

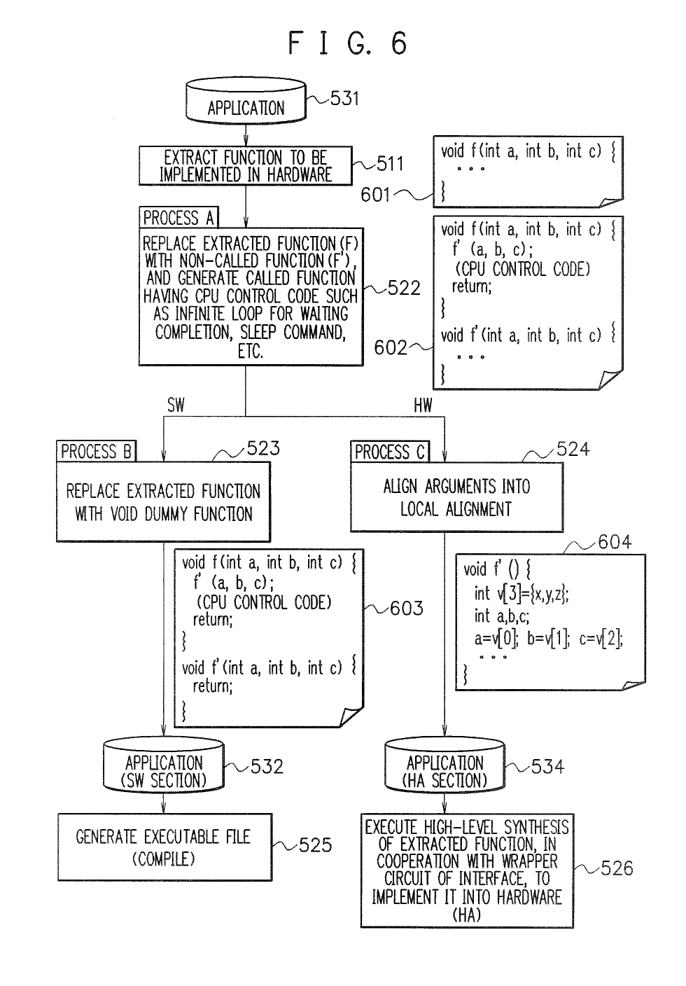

FIG. 5 is a drawing for explaining a method of designing the SoC 201, and FIG. 6 is a flow chart illustrating details of the method of designing. A computer 502 is a designing apparatus for designing the SoC 201. A storage device 503 stores an application 531 of the SoC 201. The application 531 is a program written in high-level language (System C, for example) intended to be executed by the central processing unit 212. In step 511, an operator 501 extracts a function 601 to be implemented in hardware from the application 531. By implementing the function of a part of the program to be executed by the central processing unit 212, and by generating the hardware accelerator 213 implemented in hardware, it is now possible to increase rate of processing, or to achieve cost reduction and saving of power consumption through replacement of a high-performance central processing unit with a low-performance central processing unit. Next, in step 512, the operator 501 directs the computer 502 to execute a conversion script. Then in step 521, the computer 502 executes the conversion script. Step 521 includes steps 522 to 524.

In step 522, the computer 502 generates a function 602 as a result of conversion based on the extracted function 601, by executing the conversion script. More specifically, the computer 502 replaces the content of the extracted function f with a non-called function f′, and generates a called function f (function 602) having a “CPU control code”, which indicates the state of waiting for completion of process, inserted after the function f′. The non-called function f′ is a dummy function whose content is void. The “CPU control code”, which indicates the state of waiting for completion of process, is typically a control code for infinite loop operation or issuance of sleep command. Accordingly, it is now possible that the function f is executed by the hardware accelerator 213, rather than by a program of the central processing unit 212.

Steps 523 and 525 represent operations for generating software (SW) of the central processing unit 212. In contrast, steps 524 and 526 represent operations for generating design data of hardware (HW) of the hardware accelerator 213.

Next, in step 523, the computer 502 replaces the extracted function 601 with a function 603 generated in step 522, by executing the conversion script. For example, the computer 502 replaces the extracted function f with the void dummy function f′. More specifically, as described in step 522, in order to enable the hardware accelerator 213 to execute the content of the function f having arguments in the program to be processed by the central processing unit 212, a first converter of the computer 502 replaces the content of the function f having arguments in the program to be processed by the central processing unit 212 with the “CPU control code” which indicates the state of waiting completion by the hardware accelerator 213.

Thereafter, the computer 502 writes a program of the replaced function into the storage device 503, as an application (software section) 532. The application (software section) 532 is a software section in the application 531, and is executed by a program of the central processing unit 212.

For example, the function f (function 603) contains integer data a, b, c as the arguments. In the process of execution of the function f (function 603) of the application (software section) 532, first, the central processing unit 212 writes the integer data a, b and c as the arguments and the base address into the stack memory 222 of the internal memory 214, and executes the function f′. In the function the central processing unit 212 executes nothing, and returns to the function f upon reception of a “return” command. Thereafter, in the function f, the central processing unit 212 executes a process for waiting completion of process by the hardware accelerator 213, according to the “CPU control code”.

Next, in step 513, the operator 501 directs the computer 502 to run a compiler. Then in step 525, the computer 502 compiles the application (software section) 532 written in high-level language, into an executable file written in machine language. More specifically, in order to make the central processing unit 212 process the application (software section) 532 of the program of the function replaced by step 523, a compiler unit of the computer 502 compiles the application (software section) 532 of the program of the function replaced by step 523 to thereby generate an executable file (binary file) 533, and writes the executable file 533 into the storage device 503.

In step 524, in succession to step 523, in order to enable the hardware accelerator 213 to execute the content of the function f having arguments in the program to be processed by the central processing unit 212, a second converter of the computer 502 aligns the argument of the function into a local alignment, as indicated by a function 604, according to a conversion script, and writes it as an application (hardware section) 534 into the storage device 503.

For example, in the function 604, integer data V[0], V[1] and V[2] are local alignments composed of three-integer data, and integer data a, b and c are local variables. In the local alignments V[0], V[1] and V[2], argument data in the stack memory 222 of the internal memory 214 are stored. Thereafter, data of local alignments V[0], V[1] and V[2] are stored in the local variables a, b and c, respectively. Thereafter, a process same as the function 601 is executed.

More specifically, in the hardware accelerator 213 illustrated in FIG. 3, the finite state machine 232 designates the stack readout address 245, read the argument data in the stack memory 222 of the internal memory 214 through the path 249, and stores them in the local alignments V[0], V[1] and V[2]. Next, the finite state machine 232 stores the data in the local alignments V[0], V[1] and V[2] respectively into local variables a, b and c in the register 302.

Next, in step 514, the operator 501 directs the computer 502 to execute high-level synthesis. Then in step 526, a high-level synthesizer unit of the computer 502 executes, in cooperation with the wrapper circuit 535 of the interface 301 (FIG. 3), high-level synthesis of locally-aligned functions so as to implement them into hardware, generates design data 536 of the hardware accelerator 213, and writes them into the storage device 503. The wrapper circuit 535 of the interface 301 is an interface circuit which allows the function 231 (FIG. 3) implemented in hardware to access the internal bus 211 (FIG. 2). The high-level synthesis generates RTL design data implemented in hardware, based on program written in high-level language such as System C. Based on the RTL design data, the hardware accelerator 213 is generated.

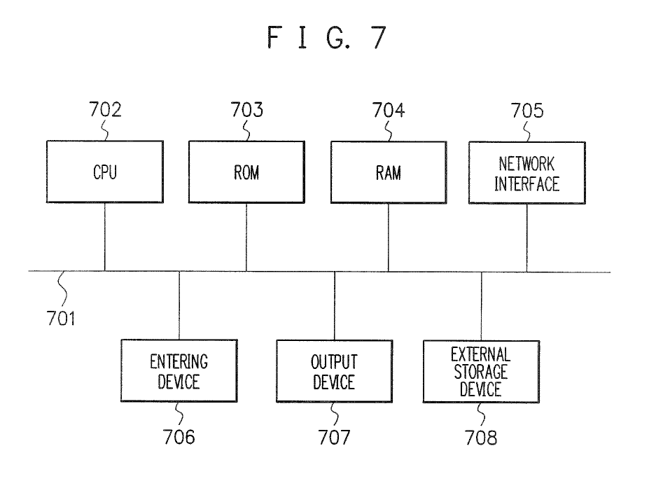

FIG. 7 is a drawing illustrating an exemplary configuration of the hardware of the computer (designing apparatus) 502 illustrated in FIG. 5. A central processing unit (CPU) 702, a ROM 703, a RAM 704, a network interface 705, an entering device 706, an output device 707 and an external storage device 708 are connected to a bus 701. The central processing unit 702 takes part in processing or calculation of data, and in controlling various constituents connected through the bus 701. The ROM 703 has a control procedure (computer program) of the central processing unit 702 preliminarily stored therein, and the computer program is started upon being executed by the central processing unit 702. The computer program is stored in the external storage device 708, copied to the RAM 704, and executed by the central processing unit 702. The RAM 704 is used as a working memory for data input/output and data reception/transmission, and as a temporary storage for control of the various constituents. The external storage device 708 is typically a hard disk storage device, CD-ROM or the like, the contents of which is not lost if power supply is interrupted. The central processing unit 702 executes the computer program in the RAM 704, so as to allow the computer 502 to proceed processes illustrated in FIG. 5 and FIG. 6. The network interface 705 is an interface for assisting connection to a network. The entering device 706 is typically a keyboard, mouse, and so forth, through which various types of designation, entering or the like are accepted. The output device 707 is typically a display device, printer or the like. For example, the external storage device 708 corresponds to the storage device 503 illustrated in FIG. 5.

The processes illustrated in FIG. 5 and FIG. 6 may be implemented by the computer 502 through execution of the program. Also a computer-readable recording medium having the program recorded therein, and a computer program product such as the above-described program may be adoptable as the embodiments herein. Recording media adoptable herein include flexible disk, hard disk, optical dick, magneto-optical disk, CD-ROM, magnetic tape, non-volatile memory card, ROM and so forth.

The SoC 201 of this embodiment enjoys a large benefit of using the hardware accelerator 213, for the case where the image, sound, signal, and other advanced calculation, for which high performance of the central processing unit 212 is required, are handled therein, aimed at being adoptable to embedded software. In this embodiment, the stack memory 222 is used as an interface between the program (software section) of the central processing unit 212 and the hardware accelerator (hardware section) 213. By virtue of this configuration, separation of the software section and the hardware section may be automated, and overhead in terms of process performance for controlling the hardware accelerator 213 may be avoidable. Design of the hardware accelerator 213 may be automated, and man-hour for the development may be reduced. In addition, there is no overhead ascribable to processing by the central processing unit 212 for starting the hardware accelerator 213, and thereby the process speed may be enhanced.

While this embodiment was configured to place the stack memory 222 into the internal memory 214, and to allow the central processing unit 212 and the hardware accelerator 213 to share the stack memory 222 through the internal bus 211, the embodiments is not limited to such configuration. For example, for the case where the stack memory 222 is placed in a local memory which is directly connected to the central processing unit 212, the local memory may be shared by the central processing unit 212 and the hardware accelerator 213 without placing the bus in between.

The embodiments described in the above are merely for exemplary purposes for implementation of the embodiments, based on which the technical scope of the embodiments will not limitedly be interpreted. In other words, the embodiments may be implemented in various ways, without departing from the technical ideas or essential features.

The embodiment successfully reduces man-hour for designing the hardware accelerator, and enables the processing device to rapidly activate the hardware accelerator.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A semiconductor circuit comprising:
a memory which stores data;
a processing device which executes a program, writes argument data of a function of the program into the memory referring to an address stored in a stack pointer, when a value of a program counter, which indicates an address of the program under execution, reaches a hardware accelerator starting address, and outputs the address stored in the stack pointer; and
a hardware accelerator which receives the address of the stack pointer from the processing device, when a value of the program counter of the processing device reaches the hardware accelerator starting address, reads the argument data of the function from the memory referring to the address stored in the stack pointer, and executes the function implemented in hardware using the argument data.

2. The semiconductor circuit according to claim 1, further comprising:
a comparator which compares the value of the program counter output by the processing device and the hardware accelerator starting address, and outputs a match signal if the both match,
wherein, upon output of the match signal by the comparator, the hardware accelerator judges that the value of the program counter reached the hardware accelerator starting address.

3. The semiconductor circuit according to claim 1,
wherein the hardware accelerator has a first adder which increments the address stored in the stack pointer and stack readout address, and outputs an address of the memory, and is configured to read argument data of the function from the memory referring to the address of the memory output from the first adder.

4. The semiconductor circuit according to claim 1,
wherein the hardware accelerator has a second adder which adds a base address read out from the memory and a data address, and outputs an address of the memory, and is configured to read or write data with respect to the memory referring to the address output from the second adder.

5. The semiconductor circuit according to claim 1, wherein the hardware accelerator has a finite state machine which executes the function implemented in hardware using the argument data.

6. A designing apparatus for designing a semiconductor circuit,
the semiconductor circuit comprising:
a memory which stores data;
a processing device which executes a program, writes argument data of a function of the program into the memory referring to an address stored in a stack pointer, when a value of a program counter, which indicates an address of the program under execution, reaches a hardware accelerator starting address, and outputs the address stored in the stack pointer; and
a hardware accelerator which receives the address of the stack pointer from the processing device, when a value of the program counter of the processing device reaches the hardware accelerator starting address, reads the argument data of the function from the memory referring to the address stored in the stack pointer, and executes the function implemented in hardware using the argument data,
the designing apparatus comprising:
a first converter which replaces a process of the function having arguments in a program to be executed by the processing device, with a process in the wait state for completion by the hardware accelerator, in order to make the hardware accelerator execute the function having arguments in the program to be executed by the processing device;
a compiler unit which generates an executable file by compiling the program of the function replaced by the first converter, in order to make the processing device execute the program having the function replaced by the first converter;
a second converter which aligns the arguments of the function into a local alignment, in order to make the hardware accelerator execute the process of the function having the arguments in the program to be executed by the processing device; and
a high-level synthesizer unit which executes high-level synthesis of the function, converted into the local alignment, so as to implement it into hardware, to thereby generate design data of the hardware accelerator.
